(19) United States
(12) Patent Application Publication
(10) Pub. No.: US 2012/0176416 A1
(43) Pub. Date: Jul. 12, 2012

(54) SYSTEM AND METHOD FOR SHAPE RECOGNITION AND CORRECTION

(75) Inventors: MEHMET DONDURUR, DHAHRAN (SA); AHMET Z. SAHIN, DHAHRAN (SA)

(73) Assignee: KING FAHD UNIVERSITY OF PETROLEUM AND MINERALS, DHAHRAN (SA)

(21) Appl. No.: 12/987,882

(22) Filed: Jan. 10, 2011

(51) Int. Cl. G09G 5/00

(52) U.S. Cl. 345/666

(57) ABSTRACT

The system and method for shape recognition and correction allows a user to hand draw a shape on a computer and replace the hand drawn shape with a corrected geometrical shape. A database of regular geometrical shapes is stored in a database in computer readable memory. A manually drawn geometric shape is stored as a first geometric data set in the memory and is displayed on a display. A best fit geometrical shape is then selected from the database, the best fit geometrical shape having contours approximately matching the contours of the manual geometric shape. The best fit geometrical shape is scaled to have dimensions approximately matching dimensions of the manual geometric shape. The best fit geometrical to shape is stored as a second geometric data set and the first geometric data set is replaced thereby. The best fit geometric shape is then displayed to the user on the display.

### BACKGROUND OF THE INVENTION

1. Field of the Invention

The present invention relates generally to computer drawing systems and methods, and particularly to a system and method for shape recognition and correction that provides for computer recognition of a hand drawn geometric shape and replacement thereof with a matching regular geometric shape image.

2. Description of the Related Art

With computers and portable computing devices being used more frequently for everyday tasks, pattern recognition, and particularly geometrical shape recognition, is becoming increasingly important. With portable computing devices, in particular, being used for note taking and sketching that permits users to hand draw shapes and symbols, it is necessary for high level pattern and shape recognition to be implemented on the computing device in order to be able to properly interpret the intended shape the user draws. Although software that permits the user to hand draw or sketch images and graphics is known, such software offers very little flexibility for the user, particularly in allowing the user to choose between automatic recognition and replacement of shapes or manual selection of various replacement options.

Thus, a system and method for shape recognition and correction solving the aforementioned problems is desired.

### SUMMARY OF THE INVENTION

The system and method for shape recognition and correction allows a user to hand draw a shape on a computer, personal digital assistant (PDA), portable device or the like, and to replace the hand drawn shape with a corrected geometrical shape. A database of regular geometrical shapes is established and stored in a database of geometrical shapes in computer readable memory. The user manually draws a manual geometric shape with a computer interface, such as a touch screen display, a drawing tablet, a light pen, a mouse or the like. The manual geometric shape is then stored as a first geometric data set in the computer readable memory. The position of the manual geometric shape relative to a display screen of the computer or portable device is also stored in the computer readable memory. The manual geometric shape is displayed to the user on the display.

A best fit geometrical shape is selected from the database of geometrical shapes, so that the best fit geometrical shape has contours approximately matching the contours of the manually drawn geometric shape. The best fit geometrical shape is then scaled to have dimensions approximately matching dimensions of the manual geometric shape.

In a first mode, the best fit geometrical shape is selected automatically. Preferably, the system requests approval for the replacement of the manual geometric shape with the best fit geometric shape before proceeding. Once approved, the best fit geometrical shape is stored as a second geometric data set in the computer readable memory and the first geometric data set is replaced with the second geometric data set. The best fit geometric shape is then displayed to the user on the display with the best fit geometric shape replacing the manual geometric shape in the same position as the manual geometric shape.

In a second mode, the best fit geometrical shape is manually selected by the user. A plurality of estimated best fit geometrical shapes from the database of geometrical shapes is displayed to the user. The user then manually selects the best fit geometrical shape from the plurality of estimated best fit geometrical shapes. In a third mode, the system attempts to automatically select the best fit geometrical shape, but if this attempt fails, then the system reverts to the second mode, where the best fit geometrical shape is manually selected by the user. In the third mode, the failure to automatically select the best fit geometrical shape may occur if the user does not approve the replacement of the manual geometric shape with the selected best fit geometric shape.

Alternatively, the automatically selected best fit geometrical shape may be compared with the manual geometric shape and a difference therebetween is calculated. If the difference exceeds a predetermined threshold value, then the system goes to the second mode, in which the best fit geometrical shape is manually selected by the user.

These and other features of the present invention will become readily apparent upon further review of the following specification and drawings.

### BRIEF DESCRIPTION OF THE DRAWINGS

FIG. 1A is an environmental perspective view of a first computer system upon which a system for shape recognition and correction according to the present invention may operate, showing a shape being manually drawn on a touch screen display.

FIG. 1B is an environmental perspective view of a second computer system upon which a system for shape recognition and correction according to the present invention may operate, showing a shape being manually drawn on a drawing tablet.

FIG. 1C is an environmental perspective view of a third computer system upon which a system for shape recognition and correction according to the present invention may operate, showing a shape being manually drawn with a computer mouse.

FIG. 2 is a screen shot of a manually drawn shape on a display in a system for shape recognition and correction according to the present invention.

FIG. 3 is a screen shot showing a first mode of operation of the system and method for shape recognition and correction according to the present invention.

FIG. 4 is a screen shot showing a second mode of operation of the system and method for shape recognition and correction according to the present invention.

FIG. 5 is a flowchart illustrating method steps of a third mode of operation of the system and method for shape recognition and correction according to the present invention.

FIG. 6 is a block diagram illustrating system components of the system for shape recognition and correction according to the present invention.

FIG. 7 is a screen shot showing a best fit geometrical shape replacing the manually drawn shape on the display of the system for shape recognition and correction.

Similar reference characters denote corresponding features consistently throughout the attached drawings.

### DETAILED DESCRIPTION OF THE PREFERRED EMBODIMENTS

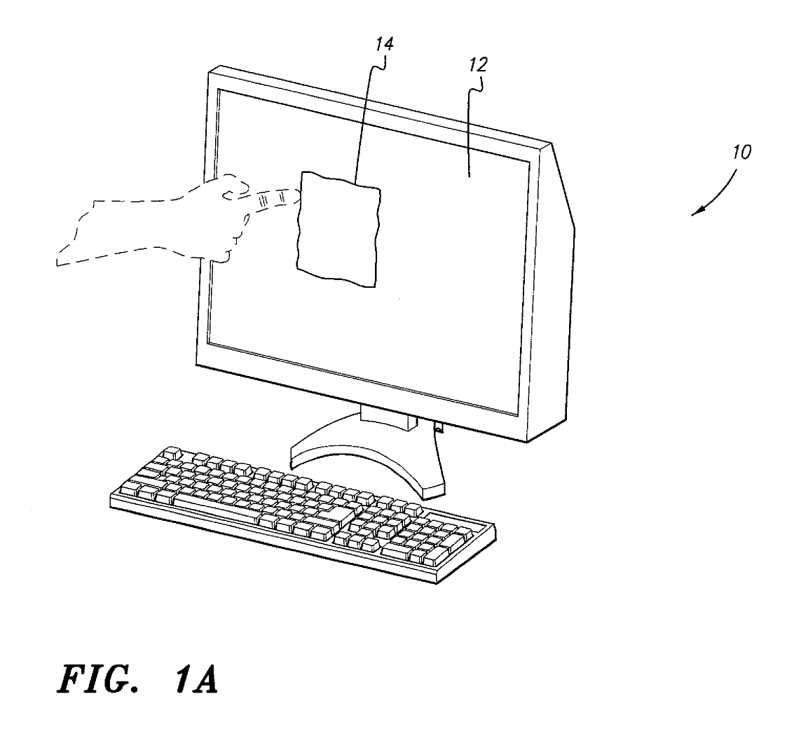

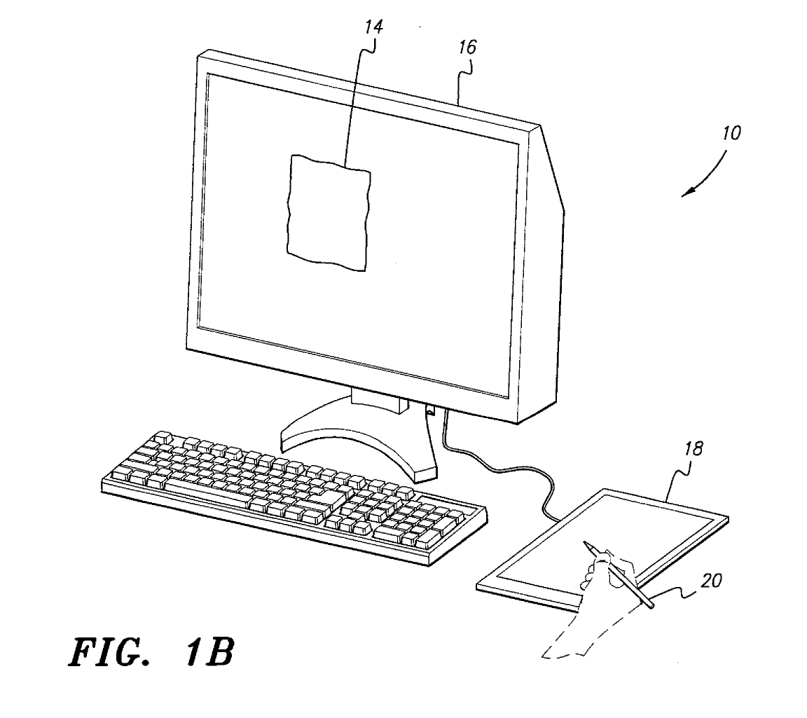

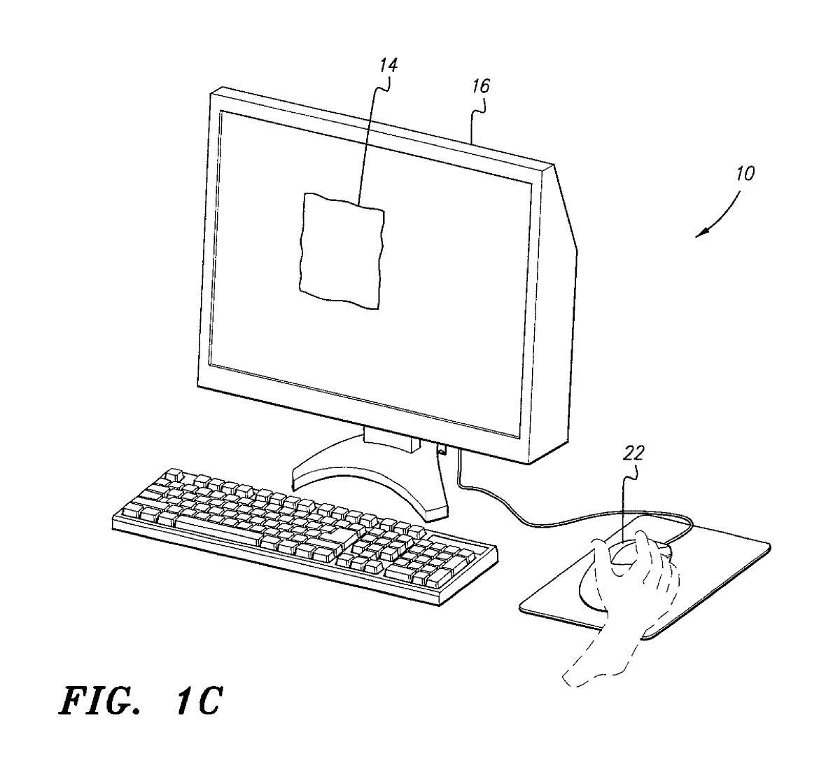

The system and method for shape recognition and correction allows a user to hand draw a shape on a computer, personal digital assistant (PDA), portable device or the like and replace the hand drawn shape with a corrected geometrical shape selected from a database stored on a computer readable medium. In FIGS. 1A, 1B and 1C, a user is shown drawing a square 14 on a touch screen 12 (in FIG. 1A), or with a drawing tablet 18 and stylus 20 (in FIG. 1B), or with a computer mouse 22 (in FIG. 1C), the square 14 being displayed on a conventional computer display 16 in FIGS. 1B and 1C. It should be understood that touch screen 12, drawing tablet 18 and computer mouse 22 are shown for exemplary purposes only, and that system 10 may be used in combination with any suitable type of user interface which allows a user to manually draw an image. Similarly, it should be understood that the computer and display are shown for exemplary purposes only and that system 10 may be incorporated into any desired type of computer, portable device or the like. Although the computer systems shown in FIGS. 1A-1C show a desk top computer system, it will be understood that the system may also operate on a PDA, notebook or laptop computer, or other portable or handheld device. Further, it should be understood that the square 14 is shown for illustrative and exemplary purposes only and that system 10 may be used to correct any desired hand drawn geometrical shape within the library of geometrical shapes stored in the database.

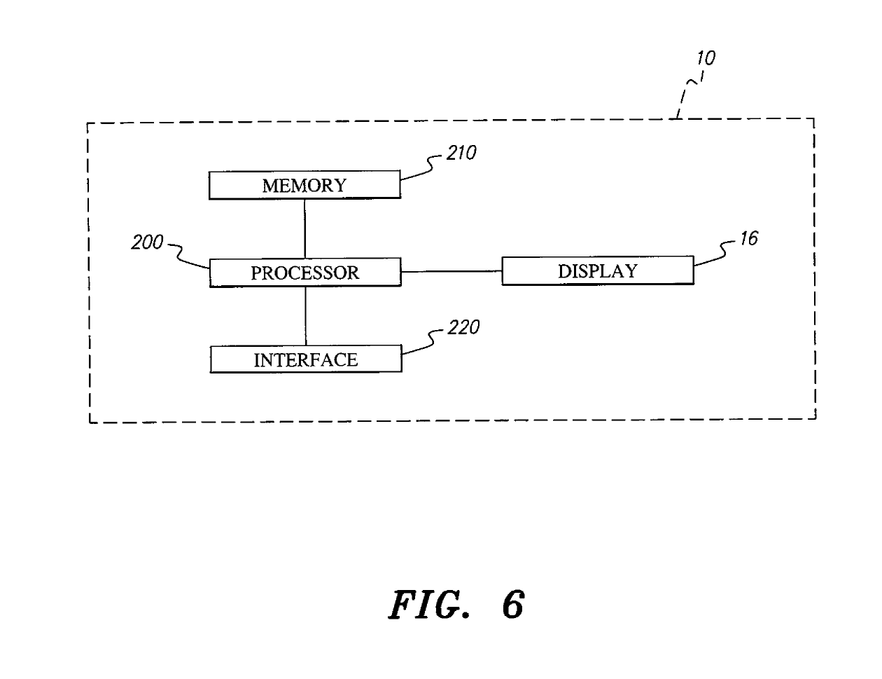

It should be understood that the calculations described below may be performed by any suitable computer system, such as that diagrammatically shown in FIG. 6. Data is entered into system 10 via any suitable type of user interface 220, and may be stored in memory 210, which may be any suitable type of computer readable and programmable memory. Calculations are performed by processor 200, which may be any suitable type of computer processor and may be displayed to the user on display 16 or touch screen 12. It should be understood that display 16 may be any suitable type of computer display. User interface 220 may be a keyboard, a drawing tablet, a mouse, a touch screen, a light pen or the like, or any desired combination thereof.

The processor 200 may be associated with, or incorporated into, any suitable type of computing device, for example, a personal computer or a programmable logic controller. The display 16, the processor 200, the memory 210 and any associated computer readable recording media are in communication with one another by any suitable type of data bus, as is well known in the art.

Examples of computer-readable recording media include a magnetic recording apparatus, an optical disk, a magneto-optical disk, and/or a semiconductor memory (for example, RAM, ROM, etc.). Examples of magnetic recording apparatus that may be used in addition to memory 210, or in place of memory 210, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

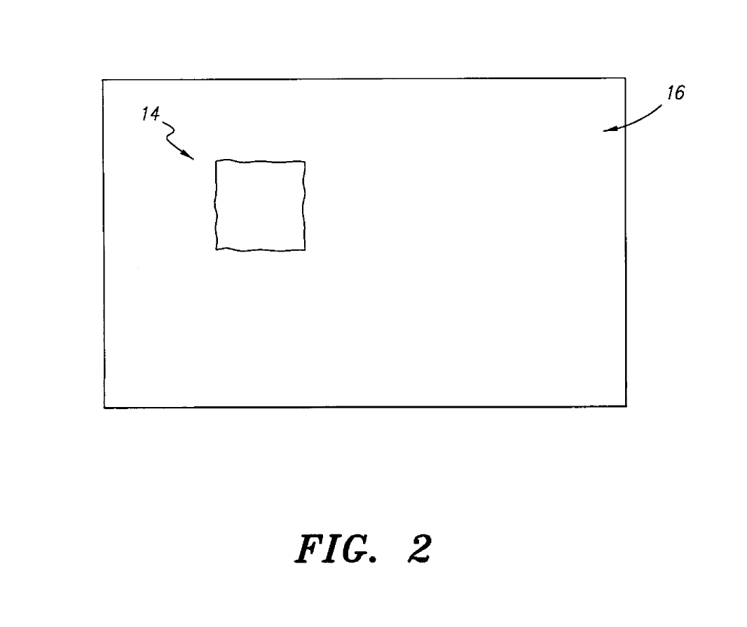

In use, a database of regular geometrical shapes is established and stored in a database of geometrical shapes in computer readable memory 210. As shown in FIGS. 1A, 1B and 1C, the user manually draws a manual geometric shape, such as square 14, with a computer interface, such as touch screen display 12, drawing tablet 18, mouse 22, light pen, or the like. The manual geometric shape 14 is then stored as a first geometric data set in the computer readable memory 210. The position of the manual geometric shape 14 relative to the display screen of the computer or portable device is also stored in the computer readable memory 210. The manual geometric shape 14 is displayed to the user on the display 16, as shown in FIG. 2.

A best fit geometrical shape 30 is selected from the database of geometrical shapes so that the best fit geometrical shape 30 has contours approximately matching the contours of the manual geometric shape. The best fit geometrical shape 30 is then scaled to have dimensions approximately matching dimensions of the manual geometric shape 14.

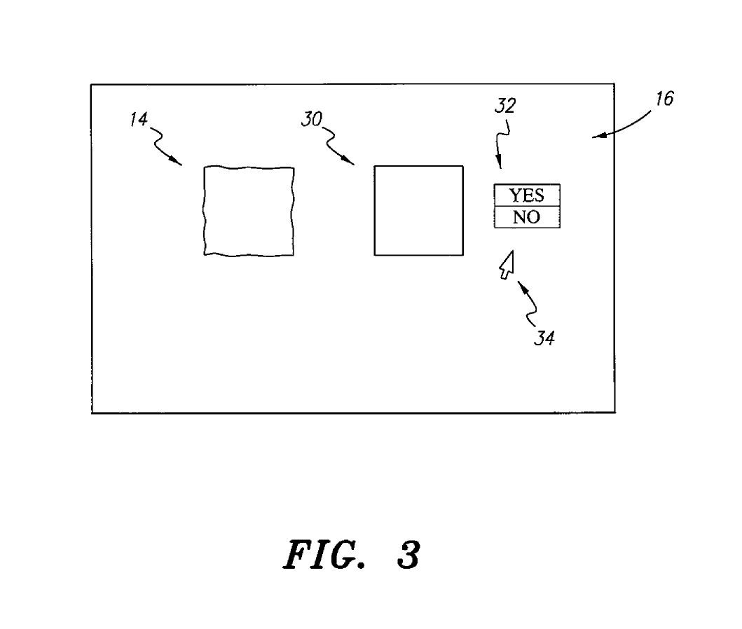

In a first mode, the best fit geometrical shape 30 is selected automatically. Preferably, the system 10 requests approval for the replacement of the manual geometric shape 14 with the best fit geometric shape 30 before proceeding. As shown in FIG. 3, the best fit geometrical shape 30 is displayed next to the manually drawn shape 14. A query box 32, requesting the user's approval, is presented and the user may move the cursor 34 to the appropriate response (or, alternatively, the user may touch the appropriate response if using touch screen 12).

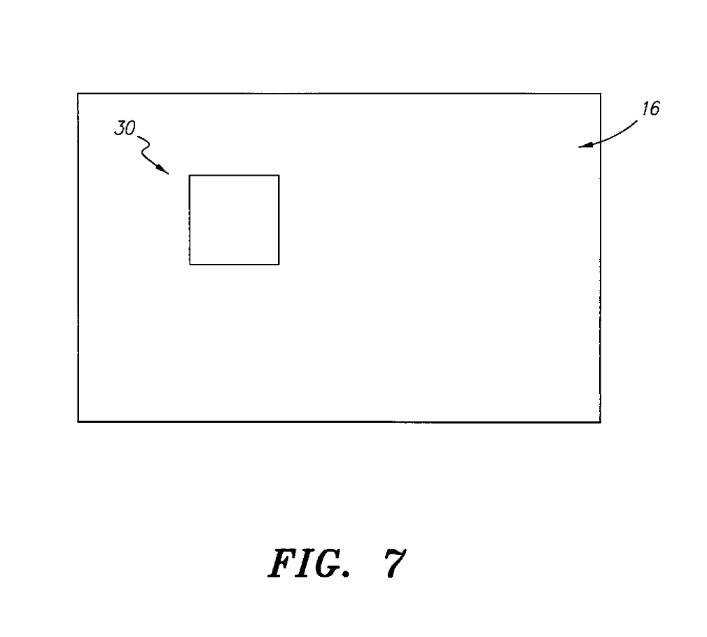

Once approved, the best fit geometrical shape 30 is stored as a second geometric data set in the computer readable memory 210 and the first geometric data set is replaced with the second geometric data set. The best fit geometric shape 30 is then displayed to the user on the display, the best fit geometric shape 30 replacing the manual geometric shape in the same position as the manual geometric shape, as shown in FIG. 7.

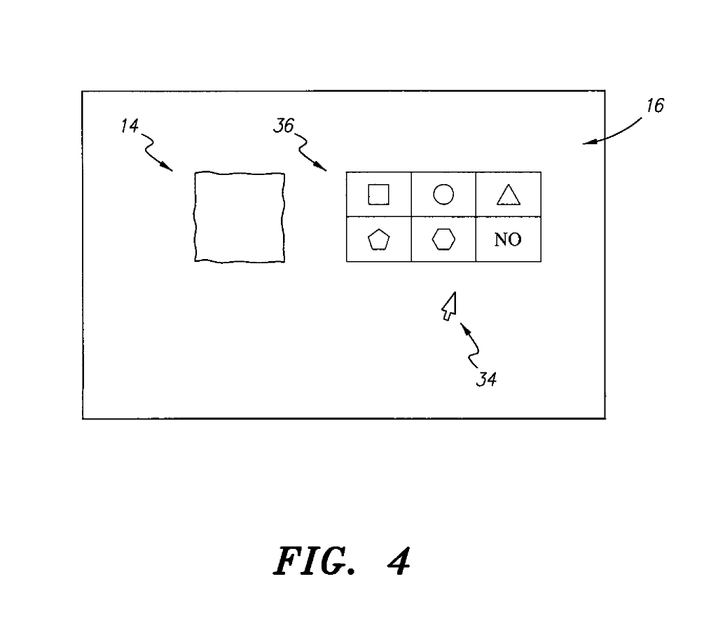

In a second mode, the best fit geometrical shape 30 is manually selected by the user, as shown in FIG. 4. A plurality of estimated best fit geometrical shapes from the database of geometrical shapes is displayed to the user in a box 36 positioned next to the manually drawn shape 14. The user then manually selects the best fit geometrical shape from the plurality of estimated best fit geometrical shapes in box 36. Once selected, the selected best fit geometrical shape 30 replaces the manually drawn shape 14, as shown in FIG. 7.

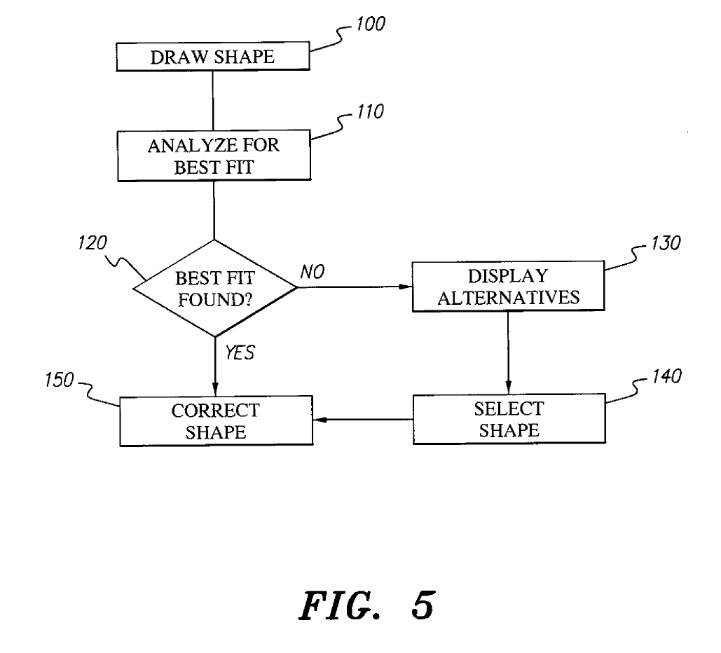

In a third mode, illustrated in the flowchart of FIG. 5, the user initially draws the shape 14 at step 100. The system implements the first, or automatic, mode at step 110, attempting to automatically find a best fit geometrical shape. If a best fit shape can be found (step 120), then the shape 14 is replaced by shape 30 at step 150, as in the first, or automatic, mode. However, if a best fit shape cannot be found, then the system 10 reverts to the second mode, displaying the plurality of estimated best fit geometrical shapes in box 36 (step 130). The user then manually selects the best fit at step 140, and the manually drawn shape 14 is replaced by the best fit geometric shape 30 at step 150. In the third mode, the failure to automatically select the best fit geometrical shape at step 120 may occur if the user does not approve the replacement of the manual geometric shape with the selected best fit geometric shape; i.e., the user selects the “NO” option in the query box 32 of FIG. 3.

Alternatively, at step 120, the automatically selected best fit geometrical shape may be compared with the manual geometric shape 14 and the difference therebetween is then calculated. If the difference exceeds a predetermined threshold value, which may be selected by the user from a preferences or options dialog box setting the default behavior of the system and method, then the system goes to the second mode, in which the best fit geometrical shape is manually selected by the user. At the beginning of the process, the user may select whether to use the first, second or third modes of operation.

It should be understood that system 10 may use any suitable type of pattern recognition or shape recognition to determine the best fit geometrical shape based on the manually drawn shape 14. Such pattern recognition systems and methods are well known in the art. Examples of such systems and methods are shown in U.S. Pat. Nos. 4,058,849; 5,544,265; 5,771,342; and 6,233,351, each of which is hereby incorporated by reference in its entirety.

It is to be understood that the present invention is not limited to the embodiments described above, but encompasses any and all embodiments within the scope of the following claims.

We claim:

1. A method for shape recognition and correction, comprising the steps of:
establishing a database of geometrical shapes;
storing the database of geometrical shapes in computer readable memory;
manually drawing a manual geometric shape with a computer interface;
storing the manual geometric shape as a first geometric data set in the computer readable memory;
storing a position of the manual geometric shape in the computer readable memory;
displaying the manual geometric shape to the user on a display;
selecting a best fit geometrical shape from the database of geometrical shapes, the best fit geometrical shape having contouring approximately matching contouring of the manual geometric shape;
scaling the best fit geometrical shape to have dimensions approximately matching dimensions of the manual geometric shape;
storing the best fit geometrical shape as a second geometric data set in the computer readable memory;
replacing the first geometric data set with the second geometric data set; and
displaying the best fit geometric shape to the user on the display, wherein the best fit geometric shape replaces the manual geometric shape in the same position as the manual geometric shape.

2. The method for shape recognition and correction as recited in claim 1, wherein said best fit geometrical shape is selected automatically.

3. The method for shape recognition and correction as recited in claim 2, wherein the step of selecting the best fit geometrical shape further comprises the step of requesting approval for the replacement of the manual geometric shape with the best fit geometric shape.

4. The method for shape recognition and correction as recited in claim 3, wherein if the user does not provide approval for the replacement of the manual geometric shape with the best fit geometric shape, then the step of selecting the best fit geometrical shape further comprises the steps of:
displaying a plurality of estimated best fit geometrical shapes from the database of geometrical shapes to the user; and
manually selecting the best fit geometrical shape from the plurality of estimated best fit geometrical shapes.

5. The method for shape recognition and correction as recited in claim 2, further comprising the step of comparing the automatically selected best fit geometrical shape with the manual geometric shape and calculating a difference therebetween.

6. The method for shape recognition and correction as recited in claim 5, wherein if the calculated difference is greater than a pre-set threshold value, then the step of selecting the best fit geometrical shape further comprises the steps of:
displaying a plurality of estimated best fit geometrical shapes from the database of geometrical shapes to the user; and
manually selecting the best fit geometrical shape from the plurality of estimated best fit geometrical shapes.

7. The method for shape recognition and correction as recited in claim 1, wherein the step of selecting the best fit geometrical shape comprises the steps of:
displaying a plurality of estimated best fit geometrical shapes from the database of geometrical shapes to the user; and
manually selecting the best fit geometrical shape from the plurality of estimated best fit geometrical shapes.

8. The method for shape recognition and correction as recited in claim 1, wherein the display is a touch screen display, so that the step of manually drawing the manual geometric shape with the computer interface comprises drawing the manual geometric shape on the touch screen display.

9. The method for shape recognition and correction as recited in claim 1, wherein the computer interface is a mouse, so that the step of manually drawing the manual geometric shape with the computer interface comprises drawing the manual geometric shape with the mouse.

10. The method for shape recognition and correction as recited in claim 1, wherein the computer interface is a drawing tablet, so that the step of manually drawing the manual geometric shape with the computer interface comprises drawing the manual geometric shape with the drawing tablet.

11. A computer software product that includes a medium readable by a processor, the medium having stored thereon a set of instructions for performing shape recognition and correction, the instructions comprising:
(a) a first set of instructions which, when loaded into main memory and executed by the processor, causes the processor to establish a database of geometrical shapes;
(b) a second set of instructions which, when loaded into main memory and executed by the processor, causes the processor to store the database of geometrical shapes in computer readable memory;
(c) a third set of instructions which, when loaded into main memory and executed by the processor, causes the processor to receive a manual geometric shape manually drawn with a computer interface;
(d) a fourth set of instructions which, when loaded into main memory and executed by the processor, causes the processor to store the manual geometric shape as a first geometric data set in the computer readable memory;
(e) a fifth set of instructions which, when loaded into main memory and executed by the processor, causes the processor to store a position of the manual geometric shape in the computer readable memory;
(f) a sixth set of instructions which, when loaded into main memory and executed by the processor, causes the processor to display the manual geometric shape to the user on a display;
(g) a seventh set of instructions which, when loaded into main memory and executed by the processor, causes the processor to select a best fit geometrical shape from the database of geometrical shapes, the best fit geometrical shape having contouring approximately matching contouring of the manual geometric shape;
(h) an eighth set of instructions which, when loaded into main memory and executed by the processor, causes the processor to scale the best fit geometrical shape to have dimensions approximately matching dimensions of the manual geometric shape;
(i) a ninth set of instructions which, when loaded into main memory and executed by the processor, causes the processor to store the best fit geometrical shape as a second geometric data set in the computer readable memory;
(j) a tenth set of instructions which, when loaded into main memory and executed by the processor, causes the processor to replace the first geometric data set with the second geometric data set; and
(k) an eleventh set of instructions which, when loaded into main memory and executed by the processor, causes the processor to display the best fit geometric shape to the user on the display, wherein the best fit geometric shape replaces the manual geometric shape in the same position as the manual geometric shape.

12. The computer software product as recited in claim 11, the instructions further comprising a twelfth set of instructions which, when loaded into main memory and executed by the processor, causes the processor to automatically select the best fit geometrical shape.

13. The computer software product as recited in claim 12, wherein the twelfth set of instructions further comprises a thirteenth set of instructions which, when loaded into main memory and executed by the processor, causes the processor to request approval for the replacement of the manual geometric shape with the best fit geometric shape.

14. The computer software product as recited in claim 13, wherein the twelfth set of instructions further comprises a fourteenth set of instructions which, when loaded into main memory and executed by the processor, causes the processor to display a plurality of estimated best fit geometrical shapes from the database of geometrical shapes to the user if the user does not provide approval for the replacement of the manual geometric shape with the best fit geometric shape.

15. The computer software product as recited in claim 12, wherein the twelfth set of instructions further comprises a fifteenth set of instructions which, when loaded into main memory and executed by the processor, causes the processor to compare the automatically selected best fit geometrical shape with the manual geometric shape and calculate a difference therebetween.

16. The computer software product as recited in claim 15, wherein the twelfth set of instructions further comprises a sixteenth set of instructions which, when loaded into main memory and executed by the processor, causes the processor to display a plurality of estimated best fit geometrical shapes from the database of geometrical shapes to the user if the calculated difference is greater than a pre-set threshold value.

17. The computer software product as recited in claim 11, wherein the twelfth set of instructions further comprises a seventeenth set of instructions which, when loaded into main memory and executed by the processor, causes the processor to display a plurality of estimated best fit geometrical shapes from the database of geometrical shapes to the user.

18. A system for shape recognition and correction, comprising:
computer readable memory;
a user interface in communication with said computer readable memory, said user interface being adapted for a user to manually draw a manual geometric shape therewith;
a display in communication with said user interface and said computer readable memory;
means for establishing a database of geometrical shapes and storing the database of geometrical shapes in the computer readable memory;
means for storing the manual geometric shape as a first geometric data set in the computer readable memory;
means for storing a position of the manual geometric shape in the computer readable memory;
means for displaying the manual geometric shape to the user on a display;
means for selecting a best fit geometrical shape from the database of geometrical shapes, the best fit geometrical shape having contouring approximately matching contouring of the manual geometric shape;
means for scaling the best fit geometrical shape to have dimensions approximately matching dimensions of the manual geometric shape;
means for storing the best fit geometrical shape as a second geometric data set in the computer readable memory;
means for replacing the first geometric data set with the second geometric data set; and
means for displaying the best fit geometric shape to the user on the display, wherein the best fit geometric shape replaces the manual geometric shape in the same position as the manual geometric shape.

19. The system for shape recognition and correction as recited in claim 18, wherein said display is a touch screen display.

20. The system for shape recognition and correction as recited in claim 19, wherein the user interface is selected from the group consisting of: a mouse and a drawing tablet.
